(19) United States
(12) Patent Application Publication
(10) Pub. No.: US 2004/0133899 A1
(43) Pub. Date: Jul. 8, 2004

(54) Optical Disk drive

(76) Inventors: Hsin-Che Hsieh, Taoyuan (TW); Ta-Yuan Lee, Taipei (TW)

Correspondence Address: QUINTERO LAW OFFICE, 1617 BROADWAY, 3RD FLOOR, SANTA MONICA, CA, 90404, US

(21) Appl. No.: 10/738,525

(22) Filed: Dec. 17, 2003

(30) Foreign Application Priority Data
Jan. 8, 2003 (TW) 92200308

(51) Int. Cl. G11B 17/03; G11B 17/04; G11B 33/02

(52) U.S. Cl. 720/601; 720/619

(57) ABSTRACT

An external optical disk drive. The optical disk drive includes a body, a carrier, and an extendable member. The carrier is mounted to the body to receive the optical disk. The extendable member slideably connects to the body. The extendable member and the body define an inner space to contain the optical disk.

### BACKGROUND OF THE INVENTION

1. Field of the Invention

The present invention relates in general to an optical disk drive. In particular, the present invention relates to an external optical disk drive that reduces volume for more convenient portable use.

2. Description of the Prior Art

When using mobile electronic devices, a storage device such as an optical storage medium (an optical disk) and a reading device such as an optical disk drive are frequently required. As volume of mobile electronic devices is more popularly reduced, the storage device and the reading device are selectively externally connected to the mobile electronic device during use. External optical disk drives are, however, limited to the size of the optical disk when volume reduction is considered. Thus, volume of the external optical disk drive cannot be further decreased for more convenient portable use.

### SUMMARY OF THE INVENTION

An object of the present invention is to provide an external optical disk drive that solves the problem described.

The optical disk drive of the present invention includes a body, a carrier, and an extendable member. The carrier is mounted to the body to receive the optical disk and can be designed as a tray. The extendable member slideably connects to the body. The extendable member and the body define an inner space to contain the optical disk when the extendable member and the body are extended. When not extended, the extendable member and the body are nested together. In this position, the extendable member and the body are in a collapsed state, and the volume of the optical disk drive is decreased. The optical disk drive in this state accommodates 3-inch mini or other small-scale optical disks, and in the extended state, supports use of both small-scale and full-size discs.

### DESCRIPTION OF THE DRAWINGS

The present invention can be more fully understood by reading the subsequent detailed description in conjunction with the examples and references made to the accompanying drawings, wherein:

FIG. 1a is a perspective diagram of a first embodiment of the present invention in a collapsed state;

FIG. 1b is a perspective diagram of an optical disk drive of the present invention in an extended state;

FIG. 1c is a local enlarged view of FIG. 1b;

FIG. 1d is a cross section along IC-IC′ line of FIG. 1c;

FIG. 1e is a schematic diagram of the present invention during portable use.

FIG. 1f is another example showing an optical disk drive in an extended state in the first embodiment;

FIG. 2 is a perspective diagram of an optical disk drive in the second embodiment;

FIG. 3 is a perspective diagram of an optical disk drive in the third embodiment;

FIG. 4 is a perspective diagram of an optical disk drive in the fourth embodiment;

FIG. 5 is a perspective diagram of an optical disk drive in the fifth embodiment.

### DETAILED DESCRIPTION OF THE INVENTION

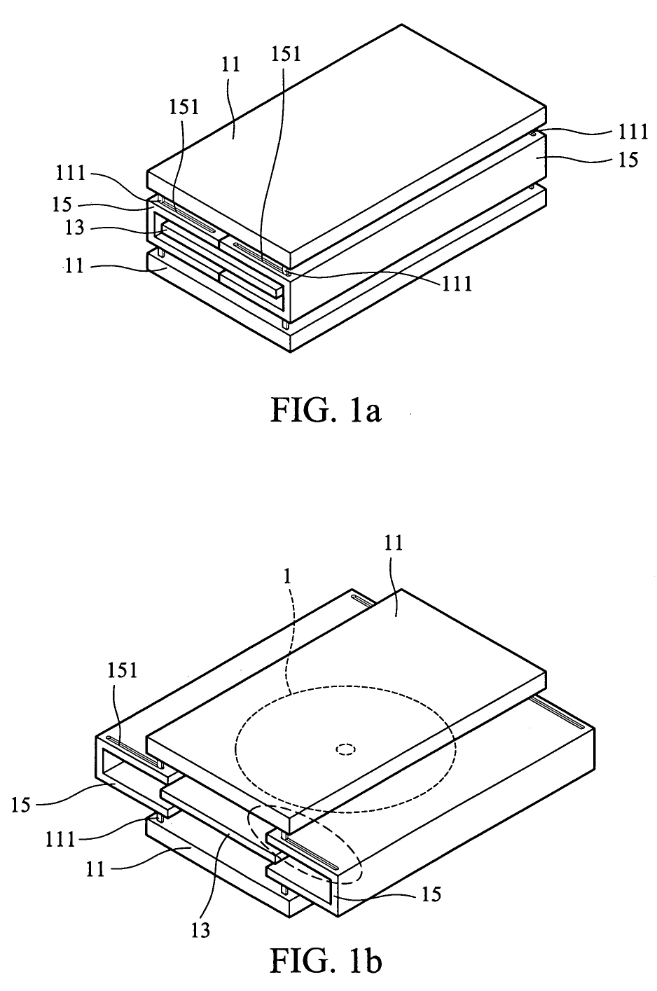

FIGS. 1a to 1f show an external optical disk drive of a first embodiment of the present invention. FIG. 1a shows the optical disk drive in a collapsed state. In this state, the optical disk drive is suitable for use with a 3-inch mini or other small-scale optical disk.

The optical disk drive 1 includes a body 11, a carrier 13, and an extendable member 15. The carrier 13 has a tray extensibly connected to the body 11. When the optical disk 1 is used, the carrier 13 receives the optical disk 1. The extendable member 15 slideably connects to the body. The extendable member 15 and the body 11 define an inner space to contain the optical disk 1. The necessary elements such as circuit, motor, clamps, and other elements are assembled in the body 11.

As shown in FIG. 1a, the extendable member 15 is contained in the body 11 when the optical disk drive of the present invention is in a collapsed state.

A protrusion 111 is disposed at each corner of the body 11 symmetrical with the cross axis of the body. Relative to the protrusion 111, a track 151 is formed on the extendable member 15. The protrusion 111 travels along the track 151 when the extendable member 15 slides with respect to the body 11.

In FIG. 1b, during use, the extendable member 15 slides with respect to the end of the body 11. The optical disk 1 is carried by the carrier 13 and contained in the extendable member 15. As shown in FIG. 1e, the diameter of the optical disk 1 is greater than the width of the carrier 13. The extending direction of the carrier 13 and the sliding direction of the extendable member 15 are perpendicular. When the optical disk drive is used, the extendable member 15 and the body 11 define an inner space to completely contain the optical disk 1, helping to avoid accidental damage.

FIG. 1c is a local enlarged view of FIG. 1b and FIG. 1d is a cross section along IC-IC′ section line of FIG. 1c. As shown in FIG. 1d, one end of a resilient member 112 connects to the body 11 and the other end connects to the protrusion 111, which travels along the track 151. A recess 153 is defined in the track 151, and the resilient member 112 biases the protrusion 111 into the recess 153 so that the extendable member 15 is fixed. A force greater than the elastic force of the resilient member 112 is applied to the extendable member 15 to separate the protrusion 111 from the recess 153 when the extendable member 15 is contained in the body 11 to form a collapsed state.

The positions of the protrusion 111 and the track 151 are not limited to those disclosed in the embodiment of the present invention. For example, it may be applicable for the protrusion 111 to be disposed at the center of the body 11 and the track 151 may be disposed at the center of the extendable member 15 corresponding to the protrusion 111.

Furthermore, another example is shown in FIG. 1f, in which the protrusion 154 is disposed at the extendable member 15 and the track 114 is disposed at the body 11 according to the protrusion 154.

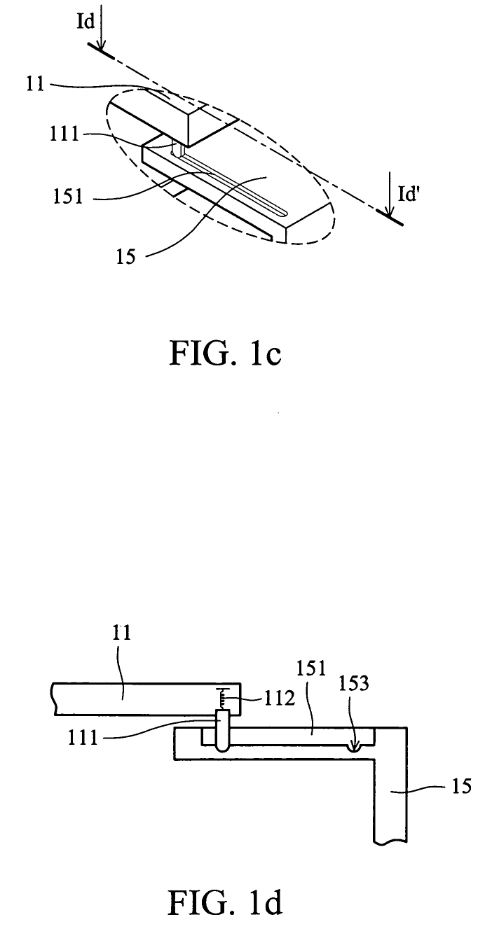

FIG. 2 shows a second embodiment of the present invention.

An external optical disk drive includes a body 21, a carrier 23, and an extendable member 25. The carrier 23 has a tray extensibly connected to the body 21. When the optical disk is used, the carrier 23 receives the optical disk. The extendable member 25 slideably connects to the body 21. The extendable member 25 and the body 21 define an inner space to contain the optical disk. The necessary elements such as circuit, motor, clamps, and other elements are assembled in the body 21.

The body 21 is contained in the extendable member 25 when the optical disk drive of the present invention is in a collapsed state.

A protrusion 211 and a track 251 match each other and are disposed at each corner of the body 21. The protrusion 211 and the track 251 are respectively selectively disposed at body 21 or the extendable member 25. In the embodiment, the protrusion 211 is disposed on the body 21 and the track 251 is disposed on the extendable member 25. The protrusion 211 travels along the track 251 when the extendable member 25 slides with respect to the body 21.

When using the optical disk drive of the present invention, the extendable member 25 slides with respect to the end of the body 21. The optical disk is received by the carrier 23 and is contained in the extendable member 25. The diameter of the optical disk exceeds the width of the carrier 23. The extending direction of the carrier 23 and the sliding direction of the extendable member 25 are perpendicular. When the optical disk drive is used, the extendable member 25 and the body 21 define an inner space to completely contain the optical disk, helping to avoid accidental damage.

Furthermore, a recess is defined in the track 251, and a resilient member (not shown) biases the protrusion 211 into the recess so that the extendable member 25 is fixed.

The positions of the protrusion 211 and the track 251 are described here as one example and are not limited to those disclosed in the embodiment of the present invention. For example, the protrusion 211 may be disposed at the center of the body 21 and the track 251 may be disposed at the center of the extendable member 25 corresponding to the protrusion 211.

Another example discloses the protrusion disposed at the extendable member 25 and the track disposed at the body 21 according to the protrusion.

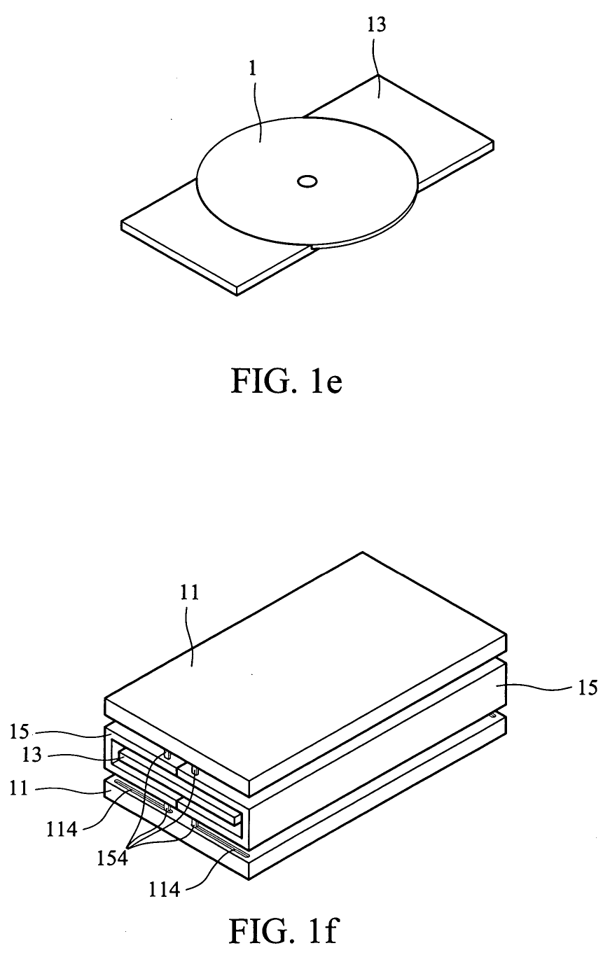

FIG. 3 shows a third embodiment of the present invention.

An external optical disk drive includes a body 31, a carrier 33, a first extendable member 35, and a second extendable member 36. The carrier 33 has a tray extensibly connected to the body 31. When the optical disk is used, the carrier 33 receives the optical disk. The first extendable member 35 and the second extendable member 36 slideably connect to the body 31. The first extendable member 35, the second extendable member 36, and the body 31 define an inner space to contain the optical disk. The necessary elements such as circuit, motor, clamps, and other elements are assembled in the body 31.

When the present invention is in a collapsed state as shown in FIG. 3, the first extendable member 35 and the second extendable member 36 are contained in the body 31. Moreover, to further decrease the width of the optical disk drive, the second extendable member 36 is narrower than the first extendable member 35 such that the first extendable member 35 receives the second extendable member 36.

A first protrusion 311 is disposed on the body 31 and a first track 351 is disposed on the first extendable member 35 according to the first protrusion 311. Similarly, a second protrusion 313 is disposed on the body 31 and a second track 361 is disposed on the second extendable member 36 according to the second protrusion 313. Thus, the first protrusion 311 travels along the first track 351 and the second protrusion 313 travels along the second track 361.

During use, the first extendable member 35 and the second extendable member 36 slide with respect to the end of the body 31. The optical disk is received by the carrier 33 and is contained in the first extendable member 35, the second extendable member 36, and the body 31. The diameter of the optical disk exceeds the width of the carrier 33. The extending direction of the carrier 33 and the sliding direction of the first extendable member 35 and the second extendable member 36 are perpendicular. When the optical disk drive is used, the first extendable member 35, the second extendable member 36, and the body 31 define an inner space to completely contain the optical disk, helping to avoid accidental damage.

When not in the extended state, the first track 351 and the second track 361 are respectively disposed in a recess. A resilient member (not shown) biases the first protrusion 311 and the second protrusion 313 into the recess so that the first extendable member 35 and the second extendable member 36 is fixed.

Furthermore, the positions of the first protrusion 311, the second protrusion 313, the first track 351, and the second track 361 are not limited to those disclosed in the embodiment of the present invention. For example, the first protrusion 311 and the second protrusion 313 may be disposed at the center of the body 31 and the first track 351 and the second track 361 at the center of the first extendable member 35 and the second extendable member 36 corresponding to the first protrusion 311 and the second protrusion 313.

Another example discloses the positions of the first protrusion, the second protrusion, the first track, and the second track being interchangeable and selectively disposed on the body 31, the first extendable member 35, or the second extendable member 36. The sole requirement is that the first protrusion correspond to the first track and the second protrusion correspond to the second track.

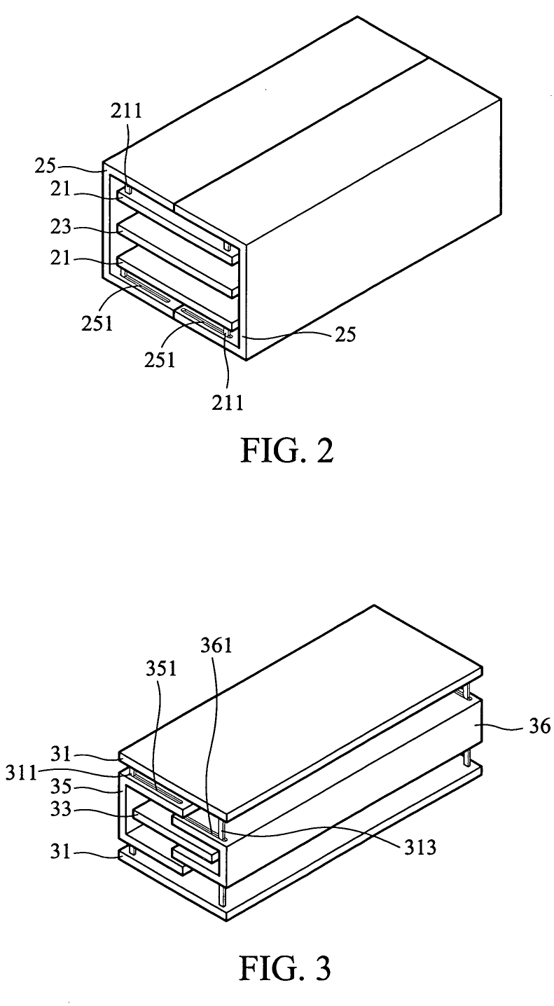

FIG. 4 shows a fourth embodiment of the present invention.

An external optical disk drive includes a body 41, a carrier 43, a first extendable member 45, and a second extendable member 46. The carrier 43 has a tray extensibly connected to the body 41. When the optical disk is used, the carrier 43 receives the optical disk. The first extendable member 45 slideably connects to the body 41 and the second extendable member 46 slideably connects to the first extendable member 45. The first extendable member 45, the second extendable member 46, and the body 41 define an inner space to contain the optical disk. The necessary elements such as circuit, motor, clamps, and other elements are assembled in the body 41.

When the present invention is in a collapsed state as shown in FIG. 4, the first extendable member 45 and the second extendable member 46 are contained in the body 41. Moreover, to further decrease the width of the optical disk drive, the first extendable member 45 and the second extendable member 46 are designed in multiple sections so that the first extendable member 45 completely receives the second extendable member 46.

A first protrusion 411 is disposed on the body 41 and a first track 451 is disposed on the first extendable member 45 according to the first protrusion 411. Similarly, a second protrusion 461 is disposed on the second extendable member 46 and a second track 453 disposed on the first extendable member 45 according to the second protrusion 461. The first track 451 and the second track 453 are on opposite surfaces of the first extendable member 45. Thus, the first protrusion 411 travels along the first track 451 and the second protrusion 461 travels along the second track 453 when the first extendable member 45 and the second extendable member 46 slide.

During use, the first extendable member 45 and the second extendable member 46 slide with respect to the end of the body 41. The optical disk is received by the carrier 43 and is contained in the inner space formed by the first extendable member 45, the second extendable member 46, and the body 41. The diameter of the optical disk exceeds the width of the carrier 43. The extending direction of the carrier 43 is perpendicular to the sliding direction of the first extendable member 45 and the second extendable member 46. When the optical disk drive is used, the first extendable member 45, the second extendable member 46, and the body 41 define an inner space to completely contain the optical disk, helping to avoid accidental damage.

When not in the extended state, the first track 451 and the second track 453 are respectively disposed in a recess. A resilient member (not shown) biases the first protrusion 411 and the second protrusion 461 into the recess so that the first extendable member 45 and the second extendable member 46 is fixed.

Furthermore, the positions of the first protrusion 411, the second protrusion 461, the first track 451, and the second track 453 are not limited to those disclosed in the embodiment of the present invention. For example, it may be applicable for the first protrusion 411 to be disposed at the center of the body 41, the second protrusion 461 at the center of the second extendable member 46, and the first track 451 and the second track 453 at the center of the first extendable member 45 corresponding to the first protrusion 411 and the second protrusion 461.

Another example discloses the positions of the first protrusion, the second protrusion, the first track, and the second track being interchangeable and selectively disposed on the body 41, the first extendable member 45, or the second extendable member 46. The sole requirement is that the first protrusion correspond to the first track and the second protrusion correspond to the second track.

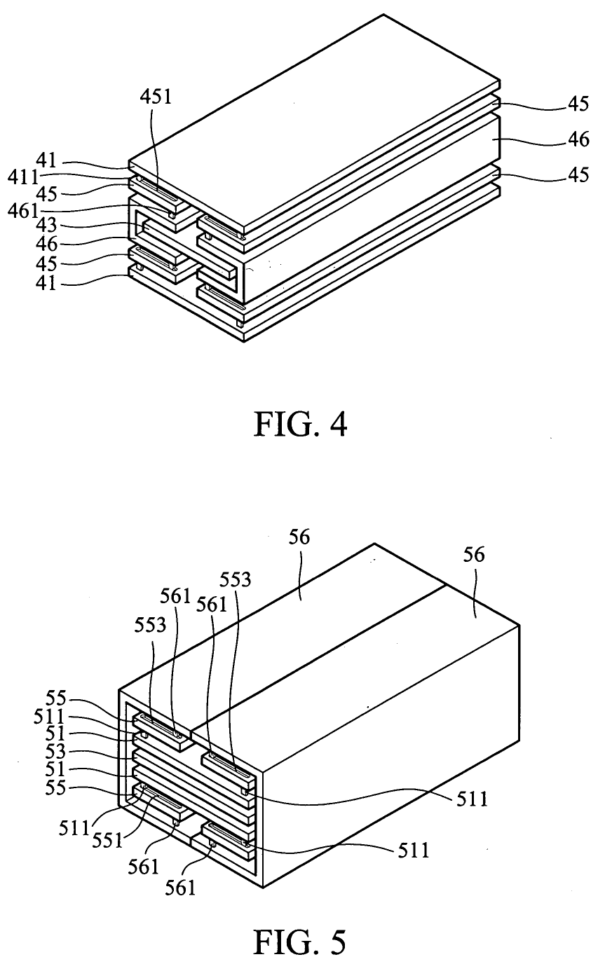

FIG. 5 shows a fifth embodiment of the present invention.

An external optical disk drive includes a body 51, a carrier 53, a first extendable member 55, and a second extendable member 56. The carrier 53 has a tray extensibly connected to the body 51. When the optical disk is used, the carrier 53 receives the optical disk. The first extendable member 55 slideably connects to the body 51 and the second extendable member 56 slideably connects to the first extendable member 55. The first extendable member 55, the second extendable member 56, and the body 51 define an inner space to contain the optical disk. The necessary elements such as circuit, motor, clamps, and other elements are assembled in the body 51.

When the present invention is in a collapsed state as shown in FIG. 5, the first extendable member 55 and the second extendable member 56 completely receive the body 51. Moreover, to further decrease the width of the optical disk drive, the first extendable member 55 and the second extendable member 56 are designed in multiple sections so that the first extendable member 55 is completely contained in the second extendable member 56.

A first protrusion 511 is disposed on the body 51 and a first track 551 is disposed on the first extendable member 55 according to the first protrusion 511. Similarly, a second protrusion 561 is disposed on the second extendable member 56 and a second track 553 is disposed on the first extendable member 55 according to the second protrusion 561. The first track 551 and the second track 553 are on opposite surfaces of the first extendable member 55. Therefore, the first protrusion 511 travels along the first track 551 and the second protrusion 561 travels along the second track 553 when the first extendable member 55 and the second extendable member 56 slide.

During use, the first extendable member 55 and the second extendable member 56 slide with respect to the end of the body 51. The optical disk is received by the carrier 53 and is contained in the inner space formed by the first extendable member 55, the second extendable member 56, and the body 51. The diameter of the optical disk exceeds the width of the carrier 53. The extending direction of the carrier 53 is perpendicular to the sliding direction of the first extendable member 55 and the second extendable member 56. When the optical disk drive is used, the first extendable member 55, the second extendable member 56, and the body 51 define an inner space to completely contain the optical disk, helping to avoid accidental damage.

When not in the extended state, the first track 551 and the second track 553 are respectively disposed in a recess. A resilient member (not shown) biases the first protrusion 511 and the second protrusion 561 into the recess so that the first extendable member 55 and the second extendable member 56 is fixed.

Furthermore, the positions of the first protrusion 511, the second protrusion 561, the first track 551, and the second track 553 are not limited to those disclosed in the embodiment of the present invention. For example, it may be applicable for the first protrusion 511 to be disposed at the center of the body 51, the second protrusion 561 at the center of the second extendable member 56, and the first track 551 and the second track 553 at the center of the first extendable member 55 corresponding to the first protrusion 511 and the second protrusion 561.

Another example discloses the positions of the first protrusion, the second protrusion, the first track, and the second track being interchangeable and selectively disposed on the body 51, the first extendable member 55, or the second extendable member 56. The sole requirement is that the first protrusion correspond to the first track and the second protrusion correspond to the second track.

As mentioned above, the external optical disk drive of the present invention has extendable members, which can slide and extend during use, to decrease the width of the optical disk drive for more convenient portable use.

Finally, when the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An optical disk drive, comprising:
a body;
a carrier mounted to the body to receive the optical disk; and
an extendable member slideably connected to the body, wherein the extendable member and the body define an inner space to contain the optical disk.

2. The optical disk drive of claim 1 wherein the body comprises a protrusion and the extendable member comprises a track, the protrusion moving along the track when the extendable member slides with respect to the body.

3. The optical disk drive of claim 2 wherein the track defines a recess to receive the protrusion.

4. The optical disk drive of claim 3 wherein the body further comprises a resilient member to biases the protrusion into the recess.

5. The optical disk drive of claim 1 wherein the extendable member is contained in the body.

6. The optical disk drive of claim 1 wherein the body is contained in the extendable member.

7. The optical disk drive of claim 1 wherein the extendable member is U-shaped.

8. The optical disk drive of claim 1 wherein the carrier has a tray extensibly connected to the body.

9. The optical disk drive of claim 8 wherein the extending direction of the tray and the sliding direction of the extendable member are perpendicular.

10. The optical disk drive of claim 1 wherein the extendable member comprises a protrusion and the body comprises a track along which the protrusion travels when the extendable member slides with respect to the body.

11. An optical disk drive, comprising:
a body;
a carrier mounted to the body to receive the optical disk;
a first extendable member slideably connected to the body; and
a second extendable member slideably connected to the body,
wherein the first and second extendable members and the body define an inner space to contain the optical disk.

12. The optical disk drive of claim 11 wherein the body comprises a first protrusion and a second protrusion, the first extendable member comprises a first track, and the second extendable member comprises a second track, such that the first protrusion travels in the first track, and the second protrusion travels in the second track.

13. The optical disk drive of claim 11 wherein the body is contained in the first and second extendable members.

14. The optical disk drive of claim 11 wherein the first and second extendable members are contained in the body.

15. The optical disk drive of claim 11 wherein the body and the second extendable member are contained in the first extendable member.

16. The optical disk drive of claim 11 wherein the carrier has a tray extensibly connected to the body.

17. A optical disk drive, comprising:
a body;
a carrier mounted to the body to receive the optical disk;
a first extendable member slideably connected to the body; and
a second extendable member slideably connected to the first extendable member,
wherein the first and second extendable members and the body define an inner space to contain the optical disk.

18. The optical disk drive of claim 17 wherein the body comprises a first protrusion, the first extendable member comprises a first track and a second track, and the second extendable member comprises a second protrusion so that the first protrusion travels in the first track and the second protrusion travels in the second track.

19. The optical disk drive of claim 17 wherein the body and the first extendable member are contained in the second extendable member.

20. The optical disk drive of claim 17 wherein the first and second extendable members are contained in the body.
